(19) United States
(12) Patent Application Publication
(10) Pub. No.: US 2025/0327936 A1
(43) Pub. Date: Oct. 23, 2025

(54) SYSTEM AND METHOD FOR NAVIGATION

(71) Applicant: Samsung Electronics Co., Ltd., Suwon-si (KR)

(72) Inventor: Rayman PON, Cupertino, CA (US)

(21) Appl. No.: 18/741,759

(22) Filed: Jun. 12, 2024

Related U.S. Application Data
(60) Provisional application No. 63/635,998, filed on Apr. 18, 2024.

(51) Int. Cl. G01S 19/34; G01S 19/04; G01S 19/10

(52) U.S. Cl. CPC G01S 19/34; G01S 19/04; G01S 19/10

(57) ABSTRACT

A system and a method are disclosed for navigation. The method may include: receiving, during a first time interval, a first sequence of samples; receiving, during a second time interval overlapping with the first time interval, a second sequence of samples; receiving, during a third time interval overlapping with the first time interval, a third sequence of samples; extracting, from the first sequence of samples, a delta carrier phase; generating a first code phase, for the second positioning signal, from the second sequence of samples; generating a second code phase, for the second positioning signal, from the third sequence of samples; generating, from: the delta carrier phase, the first code phase, and the second code phase, a smoothed code phase for the second positioning signal; and transmitting the smoothed code phase.

### CROSS-REFERENCE TO RELATED APPLICATION

This application claims the priority benefit under 35 U.S.C. § 119 (e) of U.S. Provisional Application No. 63/635,998, filed on Apr. 18, 2024, the disclosure of which is incorporated by reference in its entirety as if fully set forth herein.

### TECHNICAL FIELD

The disclosure generally relates to navigation. More particularly, the subject matter disclosed herein relates to reductions in power consumption in a navigation system.

### SUMMARY

A navigation system, such as a global navigation satellite system, may use signals from a plurality of transmitters, which may be installed on space vehicles, to allow the navigation system to estimate its position. The signal from any one transmitter may, however, be weak, or affected by multipath, or otherwise imperfect.

To solve this problem, a navigation system may use a plurality of signals, at different frequencies, from any one transmitter.

One issue with the above approach is that the power consumption of the navigation system may increase when additional signals are used.

To overcome these issues, systems and methods are described herein for turning off one or more of a plurality of receivers periodically, to save power. One receiver of the plurality of receivers may be left on to generate a delta carrier phase signal for mitigating cycle slips that may occur during intervals of time when a receiver is turned off.

The above approaches improve on previous methods because power may be saved during any interval of time when one of the receivers is turned off.

According to an embodiment of the present disclosure, there is provided a method, including: receiving, during a first time interval, a first sequence of samples, the first sequence of samples being samples of a first positioning signal, at a first frequency; receiving, during a second time interval overlapping with the first time interval, a second sequence of samples, the second sequence of samples being samples of a second positioning signal, at a second frequency; receiving, during a third time interval overlapping with the first time interval, a third sequence of samples, the third sequence of samples being samples of the second positioning signal; extracting, from the first sequence of samples, a delta carrier phase; generating a first code phase, for the second positioning signal, from the second sequence of samples; generating a second code phase, for the second positioning signal, from the third sequence of samples; generating, from: the delta carrier phase, the first code phase, and the second code phase, a smoothed code phase for the second positioning signal; and transmitting the smoothed code phase.

In some embodiments: the first positioning signal is a signal from a positioning space vehicle, and the second positioning signal is a signal from the same positioning space vehicle.

In some embodiments: the first positioning signal is a signal from a first terrestrial positioning transmitter, and the second positioning signal is a signal from a second terrestrial positioning transmitter, the second terrestrial positioning transmitters being located the same distance from a navigation system as the first terrestrial positioning transmitter, the navigation system being configured to receive the first positioning signal and the second positioning signal.

In some embodiments: the first terrestrial positioning transmitter, is at the same location as the second terrestrial positioning transmitter.

In some embodiments, the generating of the smoothed code phase includes generating the smoothed code phase using a Hatch filter.

In some embodiments, the generating of the smoothed code phase includes generating the smoothed code phase using a complementary filter.

In some embodiments, the third time interval is not contiguous with the second time interval.

In some embodiments, the first positioning signal is a signal at a first frequency from a positioning space vehicle, and the second positioning signal is a signal at a second frequency from the same positioning space vehicle.

In some embodiments, the positioning space vehicle is a Global Positioning System space vehicle.

According to an embodiment of the present disclosure, there is provided a system, including: a first receiver; a second receiver; one or more processors; and a memory storing instructions which, when executed by the one or more processors, cause performance of: receiving, during a first time interval, a first sequence of samples, the first sequence of samples being samples of a first positioning signal, at a first frequency; receiving, during a second time interval overlapping with the first time interval, a second sequence of samples, the second sequence of samples being samples of a second positioning signal, at a second frequency; receiving, during a third time interval overlapping with the first time interval, a third sequence of samples, the third sequence of samples being samples of the second positioning signal; extracting, from the first sequence of samples, a delta carrier phase; generating a first code phase, for the second positioning signal, from the second sequence of samples; generating a second code phase, for the second positioning signal, from the third sequence of samples; generating, from: the delta carrier phase, the first code phase, and the second code phase, a smoothed code phase for the second positioning signal; and transmitting the smoothed code phase.

In some embodiments: the first positioning signal is a signal from a positioning space vehicle, and the second positioning signal is a signal from the same positioning space vehicle.

In some embodiments: the first positioning signal is a signal from a first terrestrial positioning transmitter, and the second positioning signal is a signal from a second terrestrial positioning transmitter, the second terrestrial positioning transmitters being located the same distance from a navigation system as the first terrestrial positioning transmitter, the navigation system being configured to receive the first positioning signal and the second positioning signal.

In some embodiments: the first terrestrial positioning transmitter, is at the same location as the second terrestrial positioning transmitter.

In some embodiments, the generating of the smoothed code phase includes generating the smoothed code phase using a Hatch filter.

In some embodiments, the generating of the smoothed code phase includes generating the smoothed code phase using a complementary filter.

In some embodiments, the third time interval is not contiguous with the second time interval.

In some embodiments, the first positioning signal is a signal at a first frequency from a positioning space vehicle, and the second positioning signal is a signal at a second frequency from the same positioning space vehicle.

In some embodiments, the positioning space vehicle is a Global Positioning System space vehicle.

According to an embodiment of the present disclosure, there is provided a system, including: a first receiver; a second receiver; means for processing; and a memory storing instructions which, when executed by the means for processing, cause performance of: receiving, during a first time interval, a first sequence of samples, the first sequence of samples being samples of a first positioning signal, at a first frequency; receiving, during a second time interval overlapping with the first time interval, a second sequence of samples, the second sequence of samples being samples of a second positioning signal, at a second frequency; receiving, during a third time interval overlapping with the first time interval, a third sequence of samples, the third sequence of samples being samples of the second positioning signal; extracting, from the first sequence of samples, a delta carrier phase; generating a first code phase, for the second positioning signal, from the second sequence of samples; generating a second code phase, for the second positioning signal, from the third sequence of samples; generating, from: the delta carrier phase, the first code phase, and the second code phase, a smoothed code phase for the second positioning signal; and transmitting the smoothed code phase.

In some embodiments: the first positioning signal is a signal from a positioning space vehicle, and the second positioning signal is a signal from the same positioning space vehicle.

### BRIEF DESCRIPTION OF THE DRAWINGS

In the following section, the aspects of the subject matter disclosed herein will be described with reference to exemplary embodiments illustrated in the figures, in which:

FIG. 1A is a system level diagram of a set of transmitters and a navigation system, according to an embodiment.

FIG. 1B is a system level diagram of a navigation system, according to an embodiment.

FIG. 2A is a system level diagram of a navigation engine, according to an embodiment.

FIG. 2B is a system level diagram of a navigation engine, according to an embodiment.

FIG. 3A is a graph showing an operating mode, according to an embodiment.

FIG. 3B is a graph showing an operating mode, according to an embodiment.

FIG. 3C is a graph showing an operating mode, according to an embodiment.

FIG. 3D is a graph showing an operating mode, according to an embodiment.

FIG. 3E is a graph showing an operating mode, according to an embodiment.

FIG. 4 is a flow chart, according to an embodiment.

FIG. 5 is a block diagram of an electronic device in a network environment, according to an embodiment.

FIG. 6 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

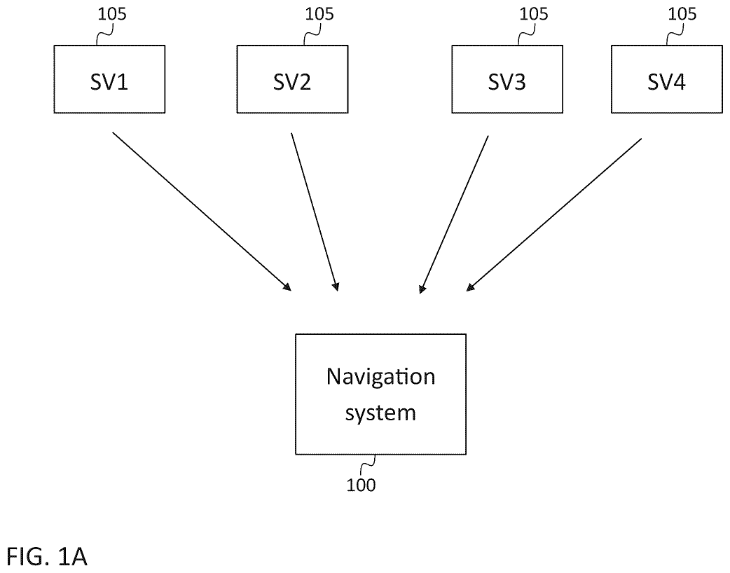

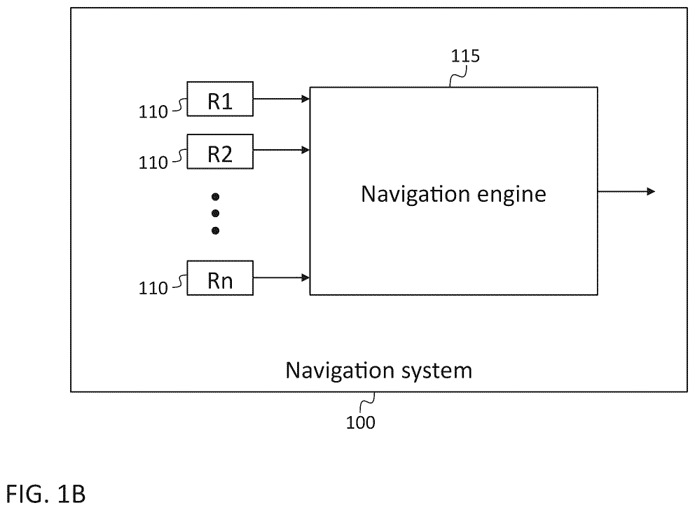

FIG. 1 one is a system level diagram showing a navigation system 100 and a plurality of satellite transmitters or “positioning space vehicles” positioning space vehicles 105. The navigation system 100 receives signals from one or more of the space vehicles 105 and, from these signals estimates the ranges to the space vehicles 105, and infers its own position with respect to the space vehicles 105. Because the positions of the space vehicles 105 with respect to a set of coordinates centered on the Earth, for example, may be known to the positioning receiver, it may calculate, for example, from the ranges, its position on the surface of the Earth. Each space vehicle 105 may transmit a plurality of signals at a plurality of respective carrier frequencies. Each of the signals may include a carrier modulated by a digital code.

Each positioning space vehicle maybe a member of our respective constellation of positioning space vehicles. Each such consolation may be part respectively of a global navigation satellite system (GNSS). For example, the constellation or constellations of which the positioning space vehicles are members may include one or more of the Global Positioning System (GPS), the Global Navigation Satellite System (GLONASS), the Indian Regional Navigation Satellite System (IRNSS), the BeiDou Navigation Satellite System (BDS), and Galileo. Each such constellation may use one or more respective frequencies unique to the constellation, or it may use frequencies overlapping with other constellations. For example, the Global Positioning System may include transmitters transmitting at five different frequencies refer to as L1 through L5 respectively, with L1 being 1575.42 megahertz, L2 being 1227.60 megahertz, L3 being 1381.05 megahertz, L4 being 1379.913 megahertz, and L5 being 1176.45 megahertz. The transmitters in each positioning space vehicle may be synchronized to a high accuracy clock such as, for example, an atomic clock.

FIG. 1B shows a block diagram of the navigation system 100. The navigation system 100, as illustrated, includes a plurality of receivers 110 (in blocks containing the text “R1” (for receiver 1), “R2” (for receiver 2) and “Rn” (for receiver n)), and a navigation engine 115. Each receiver 110 may be responsible for receiving a respective frequency from a respective space vehicle 105 of a respective constellation. As such there may be a number of receivers 110 for each of the constellations from which signals are received. The receivers 110 may be implemented in part in hardware and in part in software or in firmware or in purpose-built processing hardware, and some of the hardware may be shared, so that it may be the case that the receivers 110 are not physically entirely distinct.

Instead, for example a plurality receivers 110 receiving the same carrier frequency from each of a plurality of positioning space vehicles, for example a number of receivers 110 each receiving Global Positioning System frequency L1 (1575.42 megahertz), may share a radio frequency front end. The radio frequency front end may include, for example, an antenna, a low noise amplifier, one or more mixers that may be used to mix the received radio frequency signal to one or more intermediate frequency signals, various filtering stages, and one or more analog to digital converters, for sampling both the in phase and quadrature phase components of the intermediate frequency signal. The outputs of the analog to digital converters may then be fed to a digital signal processing circuit which may be or include special purpose hardware designed to perform carrier phase estimation and code phase estimation in parallel for each of a number of signals received from respective different space vehicles 105 at the same frequency. Conceptually this special purpose hardware may be considered to be shared hardware among a plurality of receivers 110, each receiving a respective signal from a respective space vehicle 105, as illustrated in FIG. 1A.

Each receiver 110 may measure both the phase of the carrier that it receives, and the code phase. The code phase may be the phase of the code that modulates the carrier. The carrier phase may be measured as a delta carrier phase, which may be the change in the phase of the carrier between two points in time, as discussed in further detail below. The delta carrier phase (in units of cycles) may have a fractional part and an integer part, the integer part corresponding to one or more full cycles of change in the delta carrier phase between the two and the two points in time. If the receiver 110 receives signal continuously during the two points in time with respect to which the delta carrier phase is defined, then the receiver 110 may calculate the integer part of the delta carrier phase by counting complete cycles in the carrier phase as the range between the positioning space vehicle and the receiver 110 changes. If, on the other hand, the signal is interrupted for a sufficiently long time (e.g., 20 ms or more) that the receiver is not able to estimate with confidence how much the integer part of the delta carrier phase changed during the interruption, then it may not be possible to determine the delta carrier phase for two points on either side of the interruption, with confidence. Such a change in the integer part of the carrier phase that is different from what the receiver may estimate may be referred to as a cycle slip.

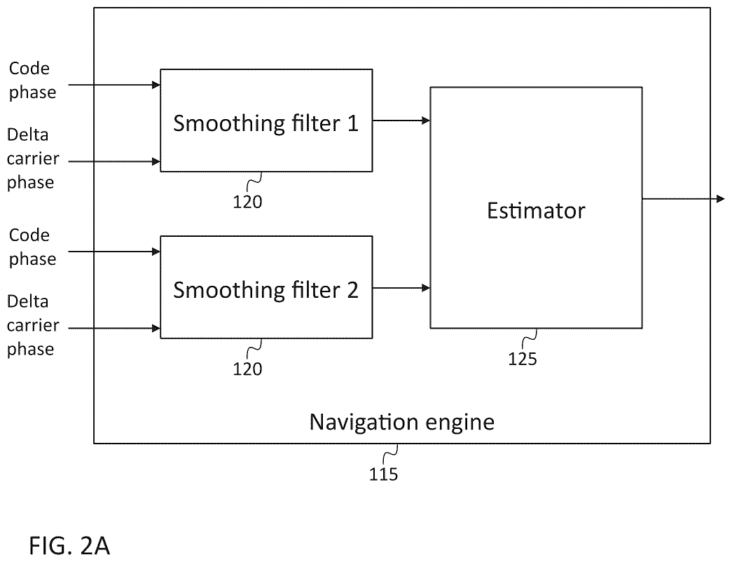

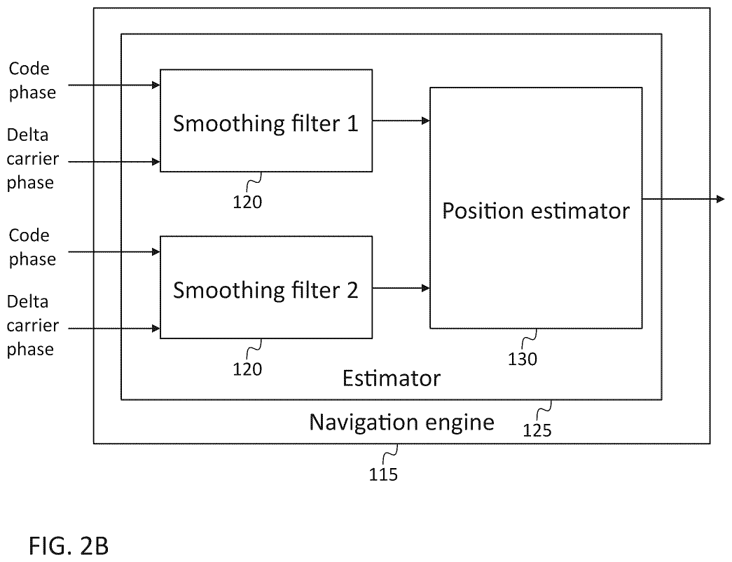

FIG. 2A shows a block diagram of a navigation engine 115, in some embodiments. Navigation engine 115 includes one or more smoothing filters 120 and an estimator 125. Each of the smoothing filters receives a code phase signal and a delta carrier phase signal from a respective one of the receivers 110. Each of the code phase signal and the delta carrier phase signal may for example be a stream of digital values, each being derived from (e.g., extracted from or generated from) one or more samples of a sequence of samples produced by, e.g., the radio frequency front end of the receiver. Each of the smoothing filters transmits, from its output, a smoothed code phase signal. The estimator 125 receives one or more smoothed code phase signals and generates a sequence of position estimates. These position estimates may be transmitted to a navigation application, for example, such as a mapping or navigation application running in a mobile telephone of a user. Each of the smoothing filters may, for example, be or include a Hatch filter, or a complementary filter. The estimator 125 may be or include, for example, a weighted least squares estimator, or, e.g., as shown in the embodiment of FIG. 2B, the estimator 125 is or includes a Kalman filter (which also includes a position estimator 130), and the smoothing filters 120 are part of the Kalman filter. The estimator may receive smooth code phase signals from two smoothing filters 120, as shown, or from more or fewer than two smoothing filters 120. The estimator may also receive signals from other sensors or inputs, such as, for example, an accelerator, or a gyroscope. As another example, in a mobile telephone application the estimator may receive positioning signals based on the cellular phone signal (e.g., a ranging signal) that the mobile telephone may receive from one or more local cell telephone base stations.

In some circumstances, as mentioned above, it may not be possible for the receiver 110 to maintain tracking of delta carrier phase. For example, if the receiver 110 moves or the space vehicle 105 moves such that an obstruction is temporarily present between the receiver 110 and the space vehicle 105, and the signal from the space vehicle 105 is temporarily lost for a sufficiently long time that the delta carrier phase may have changed by more than one cycle, then the receiver 110 may no longer be able to determine the delta carrier phase with confidence. In such a situation the delta carrier phase may be lost. This may result in a loss of positioning performance of the receiver.

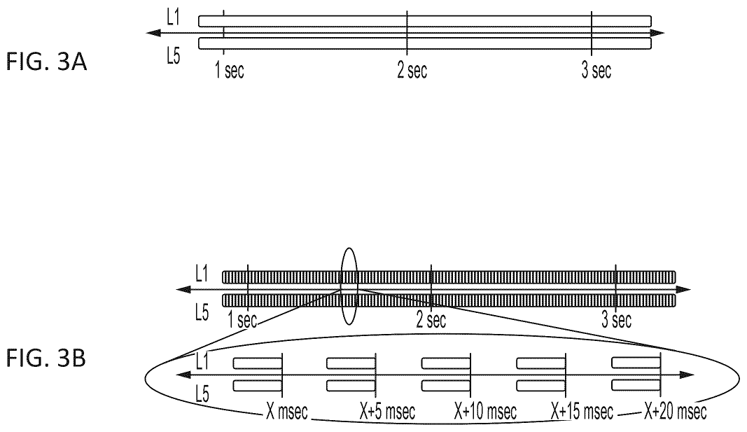

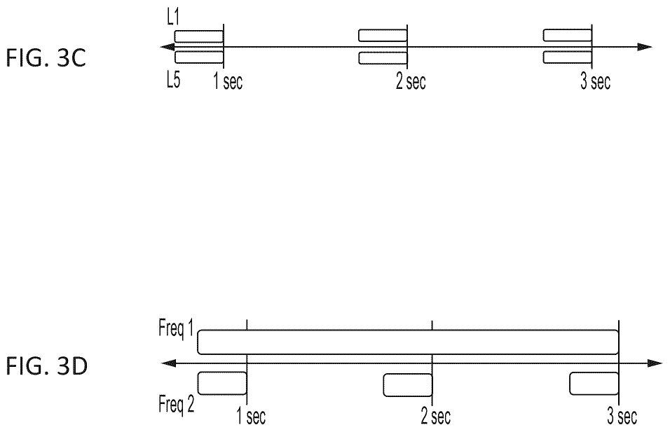

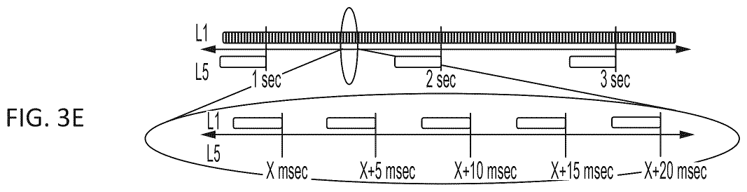

Another reason that delta carrier phase may be lost is periodic shutting down of a receiver 110 (which may be referred to as duty cycling of the receiver) of the navigation system 100. This concept is illustrated in FIGS. 3A-3D. When duty cycling of the receiver 110 is performed, the receiver 110 is turned on and off periodically with a fixed duty cycle. The advantage of operating one or more of the receivers 110 of the navigation system 100 in a duty cycling mode is that significant power may be conserved during intervals of time during the period that any receiver 110 turned off.

FIGS. 3A through 3C illustrate various different operating modes for a plurality of receivers 110. In FIG. 3A, the receivers 110 are on continuously, receiving respective signals at all times. In FIG. 3A, each receiver 110 may continuously calculate a delta carrier phase relative to a first point in time and each receiver 110 may also at all times calculate a code phase. In FIG. 3B, each of the two receivers 110 is turned on and off repeatedly with a duty cycle of 50% and a frequency of 200 hertz. In FIG. 3B, each receiver 110 may calculate a code phase whenever it is turned on, but each receiver 110 may be incapable of calculating a delta carrier phase between any two different intervals in which the receiver 110 was turned on, because of uncertainty regarding whether a cycle slip may have occurred during an interval when the receiver 110 was turned off. Such uncertainty may be present whenever the receiver is turned off during an interval exceeding about 10 ms (e.g., if the duty cycle with which the receiver is turned on and off is 50% and the frequency with which the receiver is turned on and off is less than 50 hertz). In FIG. 3C each of the two receivers 110 is turned on and off repeatedly with a duty cycle of about 30% and a frequency of 1 hertz.

FIGS. 3D and 3E show a mode of operation in which a second receiver 110 is on intermittently receiving a second frequency during the intervals when it is on, and a first receiver 110 is (i) on continuously receiving a first frequency (FIG. 3D), or (ii) (FIG. 3E) on intermittently (with a frequency of, e.g., 200 Hz and a duty cycle of e.g., 50%). The intervals during which the first receiver 110 is off in the mode of FIG. 3E are each sufficiently short that the likelihood of a cycle slip occurring is low. The frequency at which the second receiver 110 switches on and off in the example of FIGS. 3D and 3E is 1 hertz, and the duty cycle is 25%. During the intervals when the first receiver 110 is on and the second receiver 110 is off in the example of FIG. 3D, cycle slips may occur in the second receiver. As such, any delta carrier phase estimate across two intervals during each of which the second receiver 110 is on, performed based on the signal received by the second receiver, may be unreliable, because of the possibility of cycle slips during an interval in which the second receiver 110 is turned off, between two intervals during which the second receiver 110 is turned on.

In some embodiments, this is mitigated using the delta carrier phase signal from the first receiver and the first frequency. The carrier phase measured by the first receiver 110 may differ from the carrier phase measured by the second receiver 110 because of differences in ionospheric propagation delay at the two respective corresponding frequencies, and because of differences in the hardware group delay of the receive paths of the first receiver 110 and the second receiver 110, among others. These differences may be substantial, amounting to path delay differences of several meters or more, and may vary with time as conditions in the ionosphere change, and as conditions in the receiver change (e.g., group delay variations with temperature). However, the changes and relative propagation delay between the first frequency and the second frequency, and the changes and relative propagation delay between the first receiver group delay and the second receiver group delay may be relatively slow, such that over an interval of a few seconds they may amount to only a few millimeters or a few centimeters. As such, the delta carrier phase of the second frequency, estimated from the first frequency (for the integer part) and from the second frequency (for the fractional part) may be essentially the same as the delta carrier phase that would be estimated from the second frequency alone in a circumstance in which there are no cycle slips. Moreover, even an estimate of the delta carrier phase of the second frequency, estimated from the first frequency (for both the integer part and the fractional part) may be sufficiently good for certain purposes.

Because of this characteristic, the absence of a reliable delta carrier phase signal for the second frequency may be mitigated using the delta carrier phase signal from the first frequency. In some embodiments therefore (as discussed in further detail below) a delta carrier phase signal is simulated for the second frequency based on the delta carrier phase of the first frequency.

The mitigating of the absence of the delta carrier phase signal in the second frequency may be performed in any of several different ways. For example, in some embodiments the navigation engine 115, which receives, in the example of FIG. 2A, two code phase inputs and two delta carrier phase inputs, may receive at its first code phase input the code phase for the first frequency from the receiver for the first frequency (which may be referred to as the first receiver), and, at its second code phase input, the code phase from the receiver for the second frequency (which may be referred to as the second receiver). The navigation engine 115 may also receive at both delta carrier phase inputs the delta carrier phase signal from the first receiver 110, or a signal based on the delta carrier phase signal from the first receiver 110. If the delta carrier phase signal is in units of distance, for example, in units of meters, then the same delta carrier phase signal may be fed to the delta carrier phase input of the first smoothing filter, and to the delta carrier phase input of the second smoothing filter.

If the delta carrier phase signal is in units of phase, for example in units of radians, then the signal fed to the second smoothing filter may be the delta carrier phase signal from the first receiver 110, scaled in proportion to the ratio of the operating frequencies of the second receiver and the first receiver 110.

In another embodiment, the delta carrier phase signal fed to the second smoothing filter may be constructed from the delta carrier phase output of the second receiver, which may be reliable except for possible integer errors due to possible cycle slips. The integer error if any, in the delta carrier phase signal from the second receiver, may be estimated from the delta carrier phase signal from the first receiver 110 and the delta carrier phase signal from the second receiver may be corrected accordingly, before being fed to the second smoothing filter.

Significant power savings may be possible when an operating mode such as that illustrated in FIG. 3D or FIG. 3E is employed. For example, in the embodiment of FIG. 3D, the second receiver is on only 25% of the time, and as such, 75% of the power that would be consumed by the second receiver, were it on 100% of the time, may be saved. The savings may be significantly greater still, if a larger number of receivers 110 is used during normal operation. For example, if four or five receivers 110 are configured to operate simultaneously, then all of them except one may be turned off periodically to save power in a manner similar to that shown in FIG. 3D, and one of the receivers 110 alone may be left on at all times so that errors otherwise introduced by cycle slips may be avoided. The one receiver that is on at all times may avoid cycle slips and its delta carrier phase signal may be used to mitigate cycle slips (e.g., to smooth the code phase) of the other receivers 110 which operate with a duty cycle of less than 100%.

The signals received by the receivers 110 that are combined to mitigate cycle slip errors may all be transmitted by the same positioning space vehicle, and, as such, these signals may all be received from the same positioning space vehicle by the receivers 110. Because of similarities in the transmission paths, from the space vehicle 105 to the receivers 110, the transmission of these signals from a single positioning space vehicle may be sufficient to ensure that cycle slips in the signal received by one receiver will correspond to phase changes in the signal received by another receiver.

In some embodiments, terrestrial transmitters may be used in a similar manner. Such terrestrial transmitters may be referred to as pseudo-satellites, or “pseudolites”. In such an embodiment, in which the terrestrial transmitters are used as signal sources, the position of the terrestrial receivers 110 may be in the same location. For example, a first transmitter at a first frequency maybe radiating from a first transmission tower and a second transmitter at a second frequency may be radiating from the same transmission tower. In other embodiments, the two transmitters may be radiating from different transmission towers which however are separated, by a distance that is small compared to the distance between either tower and the navigation system 100, and that are separated in a direction perpendicular to the direction from the transmission towers to the navigation system 100. In such an embodiment, the range between the transmission towers and the receiver may be the same, and may change in the same manner, when the navigation system 100 is displaced.

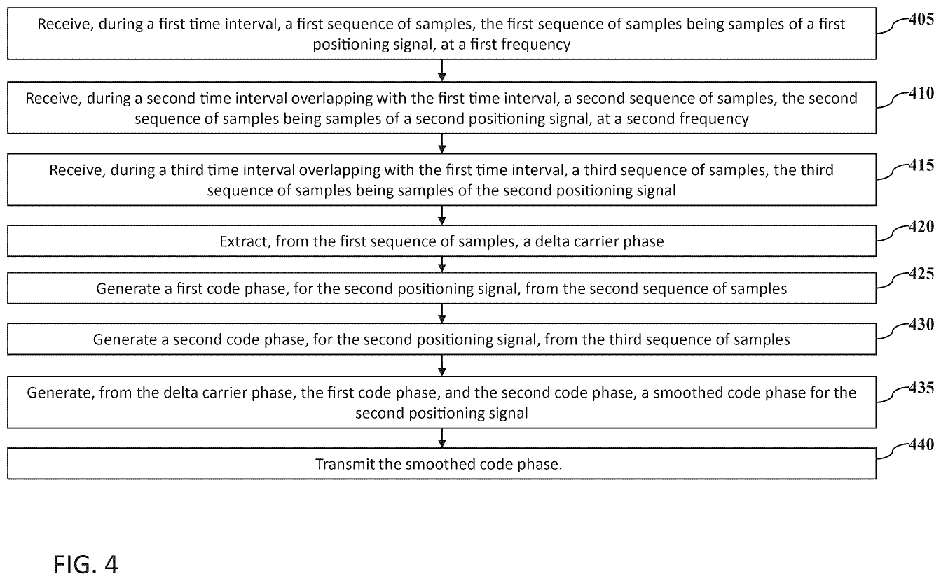

FIG. 4 shows a method, in some embodiments. Although FIG. 4 illustrates various operations in a method of verifying data transmission in a memory, embodiments according to the present disclosure are not limited thereto. For example, according to some embodiments, a method of disabling some receivers periodically in a navigation system may include additional operations or fewer operations, or the order of operations may vary (unless otherwise explicitly stated or implied) without departing from the spirit and scope of embodiments according to the present disclosure.

The method of FIG. 4 includes receiving, at 405, during a first time interval, a first sequence of samples, the first sequence of samples being samples of a first positioning signal, at a first frequency. For example, as discussed in the context of FIGS. 1A and 1B, a space vehicle 105 may transmit a plurality of code-modulated carriers signals at a plurality of respective carrier frequencies. These signals may be received, processed by a radio frequency front end, and converted to digital samples which may then be received by the subsequent processing circuitry of the navigation system 100. The first sequence of samples may be the sequence of samples corresponding to the signal received by a first receiver (e.g., the receiver receiving the signal at the first frequency (labeled “Freq 1”) in FIG. 3D), during an interval of time that overlaps the respective time intervals corresponding to a second sequence of samples and a third sequence of samples (discussed in further detail below).

The method further includes receiving, at 410, during a second time interval overlapping with the first time interval, a second sequence of samples, the second sequence of samples being samples of a second positioning signal, at a second frequency. This second sequence of samples may, for example, be the samples corresponding, in the operating mode illustrated in FIG. 3D, to the first interval of time during which the receiver at the second frequency (labeled “Freq 2”) is turned on. The method further includes receiving, at 415, during a third time interval overlapping with the first time interval, a third sequence of samples, the third sequence of samples being samples of the second positioning signal. This third sequence of samples may, for example, be the samples corresponding to the second interval of time during which the receiver at the second frequency is turned on, in the operating mode illustrated in FIG. 3D.

The method further includes extracting, at 420, from the first sequence of samples, a delta carrier phase. This may be accomplished, as discussed above, in an embodiment operating in the operating mode illustrated in FIG. 3D, by the receiver receiving the signal at the first frequency. The receiver receiving the signal at the first frequency may determine the integer part of the delta carrier phase by counting complete cycles in the carrier phase during the interval of time to which the delta carrier phase corresponds, and it may then calculate the delta carrier phase by adding to the integer part the difference between (i) the fractional carrier phase at the end of the time interval and (ii) the fractional carrier phase at the beginning of the time interval. The method further includes generating, at 425, a first code phase, for the second positioning signal, from the second sequence of samples. As discussed above, each receiver may generate a stream of code phase estimates; the first code phase may be one of these estimates, generated during the first interval of time during which the second receiver is turned on (e.g., in the operating mode of FIG. 3).

The method further includes generating, at 430, a second code phase, for the second positioning signal, from the third sequence of samples. The second code phase may be one of the code phase estimates generated by the second receiver during the second interval of time during which the second receiver is turned on (e.g., in the operating mode of FIG. 3). The method further includes generating, at 435, from (i) the delta carrier phase, (ii) the first code phase, and the (iii) second code phase, a smoothed code phase for the second positioning signal. This may involve, as described above, the use of the first delta carrier phase signal as an input to the second smoothing filter, or the use of the first delta carrier phase signal to reconstruct, from the second delta carrier phase signal (which may include cycle slips) a cycle-slip-corrected second delta carrier phase signal, which may then be fed to the delta carrier phase input of the second smoothing filter. The method further includes transmitting, at 440, the smoothed code phase. This may involve transmitting the smoothed code phase to the estimator, in the embodiment of FIG. 2A, or transmitting the smoothed code phase to the position estimator 130, in the embodiment of FIG. 2B.

As mentioned above, in some embodiments: the first positioning signal is a signal from a positioning space vehicle, and the second positioning signal is a signal from the same positioning space vehicle. In some embodiments, the first positioning signal is instead a signal from a first terrestrial positioning transmitter, and the second positioning signal is a signal from a second terrestrial positioning transmitter, the second terrestrial positioning transmitters being located the same distance from a navigation system as the first terrestrial positioning transmitter, the navigation system being configured to receive the first positioning signal and the second positioning signal. In some embodiments: the first terrestrial positioning transmitter, is at the same location as the second terrestrial positioning transmitter.

In some embodiments, the generating of the smoothed code phase includes generating the smoothed code phase using a Hatch filter. In some embodiments, the generating of the smoothed code phase includes generating the smoothed code phase using a complementary filter. In some embodiments, the third time interval is not contiguous with the second time interval, as, for example, is the case for the two time intervals, in FIG. 3D, during which the second receiver is turned on. In some embodiments, the first positioning signal is a signal at a first frequency from a positioning space vehicle, and the second positioning signal is a signal at a second frequency from the same positioning space vehicle. In some embodiments, the positioning space vehicle is a Global Positioning System space vehicle.

In some embodiments, a system includes: a first receiver; a second receiver; one or more processors; and a memory storing instructions which, when executed by the one or more processors, cause performance of: receiving, during a first time interval, a first sequence of samples, the first sequence of samples being samples of a first positioning signal, at a first frequency; receiving, during a second time interval overlapping with the first time interval, a second sequence of samples, the second sequence of samples being samples of a second positioning signal, at a second frequency; receiving, during a third time interval overlapping with the first time interval, a third sequence of samples, the third sequence of samples being samples of the second positioning signal; extracting, from the first sequence of samples, a delta carrier phase; generating a first code phase, for the second positioning signal, from the second sequence of samples; generating a second code phase, for the second positioning signal, from the third sequence of samples; generating, from: the delta carrier phase, the first code phase, and the second code phase, a smoothed code phase for the second positioning signal; and transmitting the smoothed code phase.

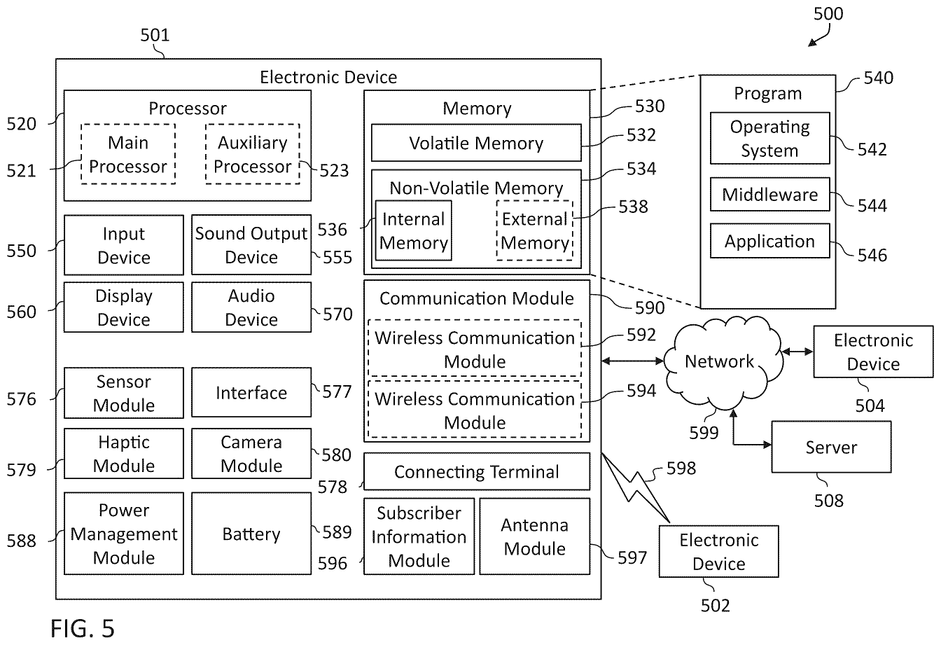

FIG. 5 is a block diagram of an electronic device 501 in a network environment 500, according to an embodiment. The electronic device may, for example, be or include a User Equipment (UE) (e.g., a mobile telephone), which may incorporate a GNSS navigation system configured to perform or implement some of all of the embodiments described herein.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

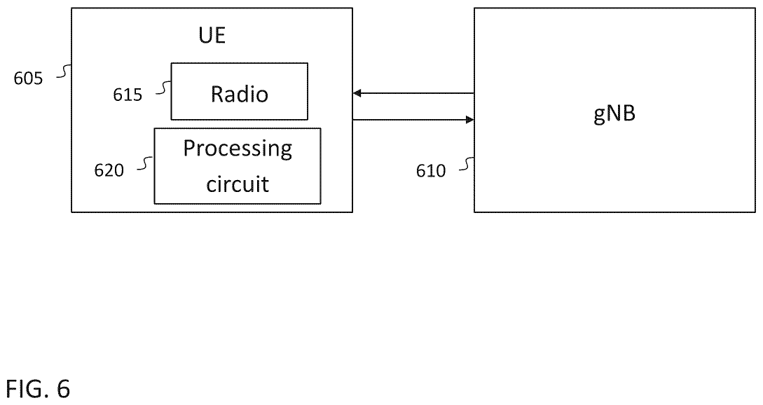

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 4. For example, the processing circuit 620 may receive, via the radio 615, transmissions from the network node (gNB) 610, and the processing circuit \hat{ }\hat{ }20 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving, during a first time interval, a first sequence of samples, the first sequence of samples being samples of a first positioning signal, at a first frequency;
receiving, during a second time interval overlapping with the first time interval, a second sequence of samples, the second sequence of samples being samples of a second positioning signal, at a second frequency;
receiving, during a third time interval overlapping with the first time interval, a third sequence of samples, the third sequence of samples being samples of the second positioning signal;
extracting, from the first sequence of samples, a delta carrier phase;
generating a first code phase, for the second positioning signal, from the second sequence of samples;
generating a second code phase, for the second positioning signal, from the third sequence of samples;
generating, from:
the delta carrier phase,
the first code phase, and
the second code phase,
a smoothed code phase for the second positioning signal; and
transmitting the smoothed code phase.

2. The method of claim 1, wherein:
the first positioning signal is a signal from a positioning space vehicle, and
the second positioning signal is a signal from the same positioning space vehicle.

3. The method of claim 1, wherein:
the first positioning signal is a signal from a first terrestrial positioning transmitter, and
the second positioning signal is a signal from a second terrestrial positioning transmitter,
the second terrestrial positioning transmitters being located the same distance from a navigation system as the first terrestrial positioning transmitter, the navigation system being configured to receive the first positioning signal and the second positioning signal.

4. The method of claim 3, wherein:
the first terrestrial positioning transmitter, is at the same location as the second terrestrial positioning transmitter.

5. The method of claim 1, wherein the generating of the smoothed code phase comprises generating the smoothed code phase using a Hatch filter.

6. The method of claim 1, wherein the generating of the smoothed code phase comprises generating the smoothed code phase using a complementary filter.

7. The method of claim 1, wherein the third time interval is not contiguous with the second time interval.

8. The method of claim 1, wherein the first positioning signal is a signal at a first frequency from a positioning space vehicle, and the second positioning signal is a signal at a second frequency from the same positioning space vehicle.

9. The method of claim 8, wherein the positioning space vehicle is a Global Positioning System space vehicle.

10. A system, comprising:
a first receiver;
a second receiver;
one or more processors; and
a memory storing instructions which, when executed by the one or more processors, cause performance of:
receiving, during a first time interval, a first sequence of samples, the first sequence of samples being samples of a first positioning signal, at a first frequency;
receiving, during a second time interval overlapping with the first time interval, a second sequence of samples, the second sequence of samples being samples of a second positioning signal, at a second frequency;
receiving, during a third time interval overlapping with the first time interval, a third sequence of samples, the third sequence of samples being samples of the second positioning signal;
extracting, from the first sequence of samples, a delta carrier phase;
generating a first code phase, for the second positioning signal, from the second sequence of samples;
generating a second code phase, for the second positioning signal, from the third sequence of samples;
generating, from:
the delta carrier phase,
the first code phase, and
the second code phase,
a smoothed code phase for the second positioning signal; and
transmitting the smoothed code phase.

11. The system of claim 10, wherein:
the first positioning signal is a signal from a positioning space vehicle, and
the second positioning signal is a signal from the same positioning space vehicle.

12. The system of claim 10, wherein:
the first positioning signal is a signal from a first terrestrial positioning transmitter, and
the second positioning signal is a signal from a second terrestrial positioning transmitter,
the second terrestrial positioning transmitters being located the same distance from a navigation system as the first terrestrial positioning transmitter, the navigation system being configured to receive the first positioning signal and the second positioning signal.

13. The system of claim 12, wherein:
the first terrestrial positioning transmitter, is at the same location as the second terrestrial positioning transmitter.

14. The system of claim 10, wherein the generating of the smoothed code phase comprises generating the smoothed code phase using a Hatch filter.

15. The system of claim 10, wherein the generating of the smoothed code phase comprises generating the smoothed code phase using a complementary filter.

16. The system of claim 10, wherein the third time interval is not contiguous with the second time interval.

17. The system of claim 10, wherein the first positioning signal is a signal at a first frequency from a positioning space vehicle, and the second positioning signal is a signal at a second frequency from the same positioning space vehicle.

18. The system of claim 17, wherein the positioning space vehicle is a Global Positioning System space vehicle.

19. A system, comprising:
a first receiver;
a second receiver;
means for processing; and
a memory storing instructions which, when executed by the means for processing, cause performance of:
receiving, during a first time interval, a first sequence of samples, the first sequence of samples being samples of a first positioning signal, at a first frequency;
receiving, during a second time interval overlapping with the first time interval, a second sequence of samples, the second sequence of samples being samples of a second positioning signal, at a second frequency;
receiving, during a third time interval overlapping with the first time interval, a third sequence of samples, the third sequence of samples being samples of the second positioning signal;
extracting, from the first sequence of samples, a delta carrier phase;
generating a first code phase, for the second positioning signal, from the second sequence of samples;
generating a second code phase, for the second positioning signal, from the third sequence of samples;
generating, from:
the delta carrier phase,
the first code phase, and
the second code phase,
a smoothed code phase for the second positioning signal; and
transmitting the smoothed code phase.

20. The system of claim 19, wherein:
the first positioning signal is a signal from a positioning space vehicle, and
the second positioning signal is a signal from the same positioning space vehicle.
